(19) United States
(12) Patent Application Publication
(10) Pub. No.: US 2021/0010935 A1
(43) Pub. Date: Jan. 14, 2021

(54) DETECTION SYSTEMS AND METHOD FOR MULTI-CHEMICAL SUBSTANCE DETECTION USING ULTRAVIOLET FLUORESCENCE, SPECULAR REFLECTANCE, AND ARTIFICIAL INTELLIGENCE

(71) Applicant: Lightsense Technology, Inc., Tucson, AZ (US)

(72) Inventors: Wade Martin Poteet, Vail, AZ (US); Terje A. Skotheim, Tucson, AZ (US)

(73) Assignee: Lightsense Technology, Inc., Tucson, AZ (US)

(21) Appl. No.: 16/921,614

(22) Filed: Jul. 6, 2020

Related U.S. Application Data
(60) Provisional application No. 62/871,521, filed on Jul. 8, 2019.

(51) Int. Cl. G01N 21/64; G01N 21/55; G01N 21/01

(52) U.S. Cl. CPC G01N 21/64; G01N 2021/0181; G01N 21/01; G01N 21/55

(57) ABSTRACT

Embodiments of this invention relate generally to detection systems and a method for chemical substance detection using UV fluorescence, specular reflectance, and artificial intelligence. In one example, a handheld detection system comprises single or multiple excitation light sources at discrete wavelengths operating in an ultraviolet portion of an electromagnetic spectrum. The single or multiple excitation light sources are operated intermittently, either all in concert or individually, at a frequency of about 100 Hz to 1000 Hz. Multiple detectors are configured as channels to operate at discrete wavelengths to detect a multiplicity of emissions produced by the excitation energy. A multi-channel electronic or software-implemented detector is synchronized in both phase and frequency with the excitation light sources so that a signal of interest is detected in the multiplicity of emissions.

### RELATED APPLICATIONS

This application claims the priority of U.S. Provisional Application No. 62/871,521, filed Jul. 8, 2019, the contents of which are incorporated by reference herein.

### FIELD OF THE INVENTION

Embodiments of this invention relate generally to chemical substance detection in stand-alone or mixtures where identification is essential to safety, law enforcement, and medical applications. Ultraviolet fluorescence and specular reflection are utilized in multiple discrete wavelength bands, along with artificial intelligence (AI) with a high degree of specificity and accuracy in order to provide identification to assist in determinations relating to legality, hazardous nature or disposition of such substances and mixtures.

### BACKGROUND

Ultraviolet fluorescence refers to the process where a substance is exposed to sufficient energy at ultraviolet and visible wavelengths between 200 nm and 900 nm and this interaction with the substance results in absorption of that energy and subsequent emission from that substance at a longer wavelength than the applied wavelength. Ultraviolet specular reflection refers to the process wherein certain wavelengths of ultraviolet energy are reflected and others either partially or totally absorbed. Other analytical methods involve absorption of certain wavelengths and not others as a substance is illuminated with ultraviolet energy, and this technique is generally employed as an analytical chemistry tool to determine the presence of a particular substance in a sample and, in many cases, to quantify the amount of the substance present. Ultraviolet-visible spectroscopy is particularly common in analytical applications. There are a wide range of experimental approaches for measuring absorption spectra. The most common arrangement is to direct a generated beam of radiation at a sample and detect the intensity of the radiation that passes through it. The transmitted energy can be used to calculate the wavelength-dependent absorption. Raman scattering spectroscopy is also used for substance identification, and excels at identifying individual substances, but significant data processing is required to separate substances in a complex mixture, and the technique is expensive.

### SUMMARY

Embodiments of this invention relate generally to detection systems and a method for chemical substance detection in stand-alone or mixtures using ultraviolet fluorescence, specular reflectance, and artificial intelligence. In one example, a handheld individual channel to multi-channel detection system comprises single or multiple excitation light sources at discrete wavelengths operating in an ultraviolet portion of an electromagnetic spectrum. The single or multiple excitation light sources are operated intermittently, either all in concert or individually, at a frequency of about 100 Hz to 1000 Hz. Multiple detectors are configured as channels to operate at discrete wavelengths to detect a multiplicity of emissions produced by the excitation energy. A multi-channel phase or frequency-sensitive electronic or software-implemented detector is synchronized in both phase and frequency with the excitation light sources so that a signal of interest is detected in the multiplicity of emissions. A processor is coupled to the detectors. Artificial intelligence (AI) is applied to the various combinations of sources activated, and their subsequent responses in the detector channels. A variable database includes known substances and subsequently learned substance signatures resulting from the AI process. Other features and advantages of embodiments of the present invention will be apparent from the accompanying drawings and from the detailed description that follows below.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a detection system used as a handheld device according to some embodiments.

FIG. 2 illustrates a block diagram of the UVF/SR detection system according to some embodiments.

FIG. 3 illustrates a method for matching measured photoemission data using AI for precise identification according to some embodiments.

FIG. 4 illustrates a diagrammatic representation of a machine in the exemplary form of a computer system or device 600 within which a set of instructions, for causing the machine to perform any one or more of the methodologies discussed herein, may be executed, in accordance with one embodiment.

### DETAILED DESCRIPTION

The present design relates generally to the field of chemical detection, inspection, and classification at wavelengths between approximately 200 nm and approximately 900 nm. In particular, a handheld UV fluorescence/specular reflection [UVF/SR] detection system with a high degree of specificity and accuracy, capable of use at small and substantial standoff distances (e.g., greater than 12 inches) is utilized to identify specific controlled substances and their mixtures in order to provide information to officials so that determinations can be made as to the legality and/or hazardous nature of such substance(s). Thus, the present design relates to a handheld system, process, and method for material detection, inspection, and classification. In particular, the present design includes a miniature electronic scanning detection system with a high degree of specificity and accuracy, operating generally in the ultraviolet portion of the electromagnetic spectrum that is used to identify specific individual and unique mixtures of substances (including remote, real-time measurements of individual chemical species in complex mixtures). By utilizing a number of illumination sources at different wavelengths and a number of detectors (not necessarily equal in number) also operating at different wavelengths, a sequence of application of these illumination sources allows for various responses in the multiple detector channels which are analyzed by artificial intelligence (AI) for specific patterns that correspond to both known and unknown substances. The simplest form of this concept involves a single illumination source and a single detector, with the amplitude of the detector's output indicating a unique substance responsive at the particular set of chosen illumination wavelength and detection wavelength.

This present design takes advantage of the fact that fluorescence emission and specular reflectance absorption occur over a range of wavelengths, so response in several discrete narrow-band detection wavelengths significantly increases the opportunity to detect substances in complex mixtures through on-board analysis by AI.

The unique spectral emissions from common controlled substances allow the process to be applied to materials such as narcotics, illicit drugs, chemical substances that are legal, but overprescribed, explosives, and toxic chemicals. All these have been observed with models of this disclosed present design. The substances may additionally include food types, synthetic drugs, prescribed narcotics, liquids, powders and the like. Biological samples can be scanned for deviations from normal molecular structures, both in the laboratory and in vivo.

The present design provides a highly specific detection approach that directly addresses three major classes of technical challenges: (1) standoff detection of low levels of substance deposition on or under a variety of surfaces in highly variable environmental circumstances with (2) an extremely low false alarm rate, and (3) rapid analysis in the handheld device itself (“real-time” analysis). Miniaturizing a UV Fluorescence/Specular Reflection (UVF/SR) detection system to a handheld unit sizes involves significant technological and engineering improvements over presently available spectrometer systems and light sources. For example, recently developed and commercially available UV light emitting diodes (LED's) can provide the necessary illumination and a bandpass filter of the proper wavelength can be utilized in front of the LED, so that only the molecules of interest are excited (the physical beam pattern of these LED's is such that two or more LED's, rotated so that their beam patterns are orthogonal to other, may be used for uniform illumination of the target of interest). Additionally, the miniaturization of detection components usually reduces overall sensitivity, so in order to increase the system sensitivity to the required level for trace detection of materials, a low-pass spectral filter (such as that illustrated herein) can be introduced into the receiving optical path for each detector channel employed in the instrument. This introduction of a low-pass spectral filter reduces unwanted light from the external environment, e.g., sunlight reduction for the UV implementation of this present design, as well as narrows the spectral bandwidth to improve the signal to noise ratio. Increases in signal to noise ratio can also be realized from suitable analog and digital filtering techniques. Further, modulating the light source(s) and utilizing synchronous detection along with advanced algorithms further improves the signal to noise ratio, which is directly related to the limit of minimum detection as well as the false positive rate. Improved signal to noise ratios, along with additional signal processing (algorithms include, but are not limited to, AI, correlation, matched filters, mean squared error, and likelihood ratio comparisons) enhances detection as well. The present design includes a handheld UVF/SR detection system including (a) a miniature scanning detection system operating in the ultraviolet to visible portion of the electromagnetic spectrum that includes (i) at least one excitation light source; (ii) a bandpass filter; (iii) a low-pass spectral filter; and (iv) ultraviolet detectors; (b) a processor coupled to the ultraviolet detectors, the processor receiving spectral data from the ultraviolet detectors; and (c) an AI computing module and database coupled to said processor that includes signature development information for a plurality of predetermined and anticipated chemical substances.

In another aspect, the present design includes a UV detection system that can include a particle concentrator including a vacuum device (e.g., portable vacuum cleaner) operatively coupled to the detection system with filter material over the intake to draw particles from the environment surrounding the area of interest and where a filter is then used as the target of the detection device. This arrangement facilitates detection of airborne particles of the material of interest.

In another aspect, a liquid concentrator is employed, such as a flow cell or flow cuvette, to concentrate a substance for coupling to the described detection system, using the concentrated liquid as the target of the detection device. This arrangement facilitates detection of airborne particles of the material of interest. In another aspect, the UVF/SR detection system of the present design emits light from single or multiple light sources, such as from an LED, laser, laser diode or flashlamp, to excite emission in different substances as well as exciting different emissions in the same substance. The light source may be pulsed, square-wave modulated, and/or continuous wave and may include single and/or multiple sources for complete scene illumination (e.g., rotate LED's, etc.).

In another aspect, the UVF/SR detection system of the present design gathers spectral signatures with a spectrally selective detector, including conventional spectrometers, spectrally filtered photodetectors, spectrometers using Multimodal Multiplex Spectroscopy™, or any other form of spectral detection. In another aspect, the detection system of the present design digitizes the obtained spectral signatures.

In another aspect, the UVF/SR detection system applies AI software and signal processing of the detection system or of a cloud entity, and when more specificity is required, a frequency-space data transformation following digitization (e.g., Fast Fourier Transform, or FFT) allows the influence of each of the processes to be separated by examining the individual coefficients of the transform series. Because certain coefficients are affected more by one process than another in this type of transform, deconvolution of the process creating the overall spectrum is possible.

In another aspect, the UVF/SR detection system of the present design displays the obtained spectral signatures and/or the results of a comparison of the obtained spectra with signatures to a database of known and/or previously obtained spectral signatures. In another aspect, the UVF/SR detection system of the present design includes a handheld and/or battery-operated device UVF/SR detection device. In another aspect, the UVF/SR detection system of the present design includes a GPS locater internally mounted within the UVF/SR detection system and/or in a handheld component of such system.

In another aspect, the UVF/SR detection system of the present design determines the distance to target in order to keep the system within a sensitive range and could adjust the detection threshold as a function of distance. In another aspect, the UVF/SR detection system of the present design communicates wirelessly to a remote location, e.g., the “cloud”. In another aspect, the UVF/SR detection system of the present design includes cell phone and/or other remote access communications capabilities, including video functions and storage.

Ultraviolet fluorescence is an analytical technique used to identify and characterize chemical and biological materials and mixtures. Modern light sources and detectors have made small handheld operation (as opposed to “transportable”) possible, and unique signal processing techniques increase sensitivity of these systems to allow detection of trace amounts of materials on surfaces. In operation, UV fluorescence systems direct energy (in the form of concentrated photons of a range of wavelengths) from an excitation source toward a target area using, for example, reflective or refractive optics. Photoelectric and other interactions of the photons with the sample material produce detectable wavelength-shifted emissions that are typically at longer wavelengths than the absorbed excitation UV photons, and specular reflection or absorption produces selected wavelength-specific portions of the originating energy reflected back to a detector. The first process involves a wavelength shift that is due to an energy transfer from the incident photons (at a specific wavelength) to the target materials. The transferred energy causes some of the sample's electrons to either break free or enter an excited (i.e., higher) energy state. Thus, these excited electrons occupy unique energy environments that differ for each particular molecular species being examined. As a result, electrons from higher energy orbital states “drop down” and fill orbitals vacated by the excited electrons. The energy lost by the electrons going from higher energy states to lower energy states results in an emission spectrum unique to each substance in the field of view of the instrument. When this process occurs in a short time, usually 100 nanoseconds or less, the resultant photon flux emission is referred to as fluorescence, although luminescence, phosphorescence, and photoluminescence are frequently used to describe these processes as well.

Another component of the present design described here involves specular reflection or absorption from the surface of the target material so that only selective portions of the incident energy spectrum are reflected, while others are absorbed.

The resultant emission spectrum generated is detected with an array of detectors, digitized and analyzed (i.e., wavelength discrimination) using unique algorithms and signal processing. Each different substance within the target area produces a distinctive spectrum that can be sorted and stored and analyzed using artificial intelligence (AI) to deconvolve the various components of that spectrum. Very complex mixtures of substances can be identified as to specifics of those components using this method.

Ultraviolet fluorescence does have some drawbacks. First, it can be affected by interference (or clutter) due to energy reflections from nearby surfaces. Interference is defined as unwanted UV flux reaching the detector that does not contribute directly to the identification of a substance of interest. For example, when attempting to detect an illegal substance on clothing, clutter can arise from exciting unimportant molecules in the target area, exciting materials close to the detector/emitter region, external flux from outside the target area (including external light sources like room lights or the sun) and scattering from air and/or dust in the light path.

UV fluorescence systems also are limited in terms of sensitivity due to distance from the substance of interest. Greater distances between the substance of interest and the excitation source and detector result in weaker return photon flux (i.e., weaker, if any, fluorescence) from the sample material.

Conventional spectroscopy and detection techniques include, among other things, neutron activation analysis, ultraviolet absorption, ion mobility spectroscopy, scattering analysis, nuclear resonance, quadrupole resonance, near infrared (NIR) reflectance spectroscopy, Raman spectroscopy, and Fourier Transform Infrared (FTIR) spectroscopy, selectively-absorbing fluorescent polymers, and various chemical sensors. Each of these methodologies, however, suffers from significant deficiencies. For example, neutron activation analyses, while capable of directly measuring ratios of atomic constituents (e.g., hydrogen, oxygen, nitrogen, and carbon) require bulky energy sources that have high power demands and thus do not lend themselves to handheld instruments. Traditional UV to NIR absorption and scattering techniques are subject to high degrees of inaccuracy (i.e., false alarms and omissions) absent sizeable reference resources and effective predictive analysis systems. Raman and FTIR spectroscopy suffer from interference by other substances being present, and incapable of detecting a substance in a matrix, e.g., illicit drugs in mixtures with other compounds such as flour, sugar, and other. Scattering analysis techniques suffer similar shortcomings. Further, these techniques do not lend themselves to “point and shoot” instruments, particularly handheld ones. Ion mobility spectroscopy devices are currently in use at many airports for “wiping” analysis, but suffer from low sensitivities in practical measuring scenarios and have high maintenance demands. Resonance Raman is an emerging and promising technology, but requires special surfaces and sample preparation for operation. Quadrupole resonance techniques offer a good balance of portability and accuracy, but are only effective for a limited number of materials (i.e., they have an extremely small range of materials they can reliably and accurately detect). These systems also suffer from outside interfering radio frequency sources such as terrestrial radio broadcast stations.

Finally, chemical analyzers such as conventional NIR spectrometers and recently marketed handheld NIR devices, have extremely limited ranges, and generally provide insufficient detailed information for chemical identification except in special circumstances. Furthermore, chemical vapor sensors do not always produce consistent results under varying environmental conditions (e.g., high humidity and modest air currents) when substantial standoff distances are involved. None of the competing technologies are capable of detecting a particular substance of interest with high sensitivity, high accuracy and embedded in a matrix of other compounds.

While accurate identification of substances is accomplished by several methods, complex mixtures of many substances are not easily deconvolved. The combination detection and analysis that this present design describes does deconvolve the individual components of mixtures and thus provides unique substance identification in these complex mixtures. Real-world samples often are comprised of these complex mixtures of substances, especially when clandestine transportation of prohibited substances occurs.

The description below is designed for at least one detector and at least one illumination source (e.g., three detectors and three illumination sources). This present design allows for the number of illumination sources and detectors to be from 1 to 1024 in one example.

For each substance to be detected, the pre-defined sequence of UV LED illuminations will generate three data sequences, each from one detector channel. The three data sequences may be summarized as an output matrix of size 6×3, where the rows correspond to the six combinations of LED illumination sequence, the columns correspond to three detector channels. The output matrix is essentially a “signature” of the substance being detected. For pure substances, each type can be uniquely mapped to a matrix and hence identified immediately by comparing with a database. When the purity of the substance changes (0˜100%), its output matrix changes accordingly. Hence, the detection of (possibly) impure substance cannot be conducted through a simple comparison with the database. An impure substance may be mapped to infinite number of possible output matrices as its purity varies continuously between 0˜100%. In this case, more advanced machine learning (ML)/AI algorithms must be used to extract the hidden “signature”/features from those output matrices that uniquely maps back to a substance.

Taking the type of substance as output of the AI algorithm, and its corresponding output matrix from the detectors as the input to an AI algorithm, we have a mapping relationship to learn:

substance type=f(detector output matrix)

Since the substances of interest are limited and pre-defined, the above becomes a multi-class classification problem where the classes are: substance #1, substance #2, . . . , substance #k, other (unknown substance). Given enough training data from lab tests, this classification problem can be well solved by methods like support vector machine, random forests, and deep neural networks. From these methods, hidden “signatures” of the substances are automatically identified by the algorithm. However, whenever physical knowledge about certain substance's detection output is available, it may be incorporated into the above algorithms and obtain a physics-data hybrid approach that is likely to significantly improve detection accuracy with a smaller training sample size. There are various methods of incorporating prior physical knowledge into data-driven methods, which can be explored in our application.

It becomes more challenging if a mixture of multiple substances is to be analyzed based on the detector outputs. The amount of input information remains unchanged (the 6×3 matrix), but multiple outputs are now expected from the ML/AI algorithm. First of all, physics-based analysis should be carried out as much as possible to distinguish substances with simple and unique signatures, which can be separated easily from other substances. This extra step has the potential to significantly reduce the difficulty of the multi-substance detection problem by pre-processing and removing some easily-detected ones. To detect multiple substances within a mixture, this design introduces a voting process using an ensemble of classifiers, where each will vote for one substance and many classifiers together allow multiple substances to receive votes. Then substances whose votes are larger than a pre-determined threshold can be declared as being present in the mixture. In particular, the random forest method has a built-in voting process, which makes it one of the natural choices for this task.

During the use of this present design, more samples can be collected and may be added to the database. The ML/AI algorithm should be updated with the new samples included. One issue is to determine when an update is needed. An algorithm will be developed to automatically identify optimal updating times, by trading off between the computation needed for each update (re-train the model) and the extra accuracy that can be achieved in detection. It is worthwhile to point out that, Bayesian methods are naturally more suitable for the setting when frequent updating is required.

Aspects of the present design are disclosed in the accompanying description. Alternate embodiments of the present design and their equivalents are devised without parting from the spirit or scope of the present design. It should be noted that like elements disclosed below are indicated by like reference numbers in the drawings.

The present design relates to a system and methods for material detection, inspection, and classification. In particular, an electronic scanning detection system (e.g., a UV fluorescence/specular reflection spectrograph) with a high degree of specificity and accuracy, operating in the ultraviolet portion of the electromagnetic spectrum, is used to identify specific individual and unique mixtures of substances (including remote, real-time measurements of individual chemical species in complex mixtures).

Preferably, the substances identified by the present design are exposed medications/materials and/or explosive and/or illegal materials that are not otherwise labeled or hidden within a sealed, opaque to transparent container. Certain embodiments of the present design, however, may be able to detect substances in a cup, bottle, plastic bag, shrink-wrapped or other container. This feature may be desirable for quality assurance programs to evaluate and monitor substances before leaving a manufacturing facility or pharmacy prior to delivery.

The present design may be configured in any number of ways, including as a handheld device, a mobile device and/or fixed mounted device. In one embodiment, the present design is capable of electronically scanning substances directly or of receiving data from an accessible scanning device. In one embodiment, identification of a substance includes analysis of the substance's electromagnetic spectrum using discrete detector channels. A generated spectrum can be cross-correlated and analyzed by comparison against other known reference information (e.g., other drugs or substances being administered to a patient in view of known genetic or health factors, known drug interactions and/or quality assurance information). The disclosed embodiments are usable without changing the physical appearance or chemical composition of the substances.

The present design has an extensive number of applications. A non-exclusive list includes, but is not limited to: any industries, processes and/or equipment requiring remote, non-invasive sensing of multiple chemical compounds or constituents (such as monitoring, commercial drug quality control and/or medication dispensing verification). Reliable detection of trace amounts of controlled substances is required in a variety of settings because the raw ingredients to manufacture these substances are widely available, and currently no detection exists that is rapid, inexpensive, non-contact, and handheld.

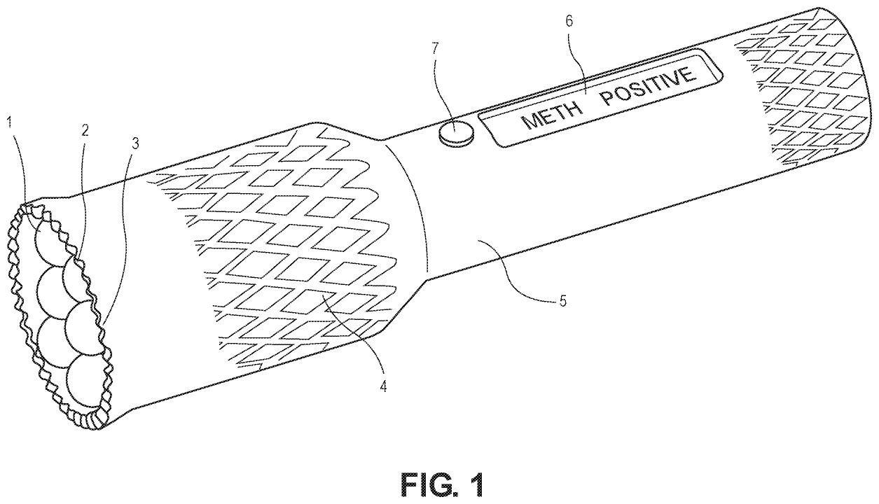

The detection systems shown in FIG. 1 may include any ultraviolet energy source with or without spectral filtering to provide the appropriate excitation energy to induce (simultaneously) photoemission and produce specular reflection in the target substance.

In order to improve the standoff distance and the size of the footprint of the detector, a source with more effective power in the required excitation spectral band can be used. Candidates include lasers, laser diodes, light emitting diodes, and powerful flash lamps. Inexpensive commercial light emitting diodes (LEDs) are beginning to be available that can provide energy on the target that is approximately 100 times greater than conventional energy sources. As such, the same detection threshold that is used in the present detector can be maintained while increasing the standoff distance from approximately 1 inch to approximately 12 inches and the effective detection footprint can be increased from approximately 0.5 inch to approximately 2¾ inches.

In the disclosed system, detection of the return photoemission is currently accomplished using an array of photodetectors or a miniature spectrometer. While this approach allows straightforward re-configuration to detection of emission from additional substances at differing wavelengths, other schemes can provide sufficient spectral detection, including individual photodiode detector/spectral filter combinations as well to lower cost and allow smaller size spectrometer designs.

The present design can include any known scanning device or combinations thereof. Computer and control electronics can also be connected to or used in tandem with the present design. The present design includes a handheld UVF/SR detections system including (a) a miniature scanning detection system operating in the ultraviolet portion of the electromagnetic spectrum that includes (i) an excitation light source; (ii) a bandpass filter; (iii) a low-pass spectral filter; and (iv) an ultraviolet fluorescence detector; (b) a processor coupled to the ultraviolet fluorescence detector, the processor receiving spectral data from the ultraviolet fluorescence detector; and (c) an AI software module coupled to said processor that includes algorithms for generating signatures for a plurality of predetermined chemical substances as well as learning capability for new substances not initially measured.

The disclosed systems may include an optical scanning device, a spectrograph (if this technique is used), a detector and an energy source. The disclosed system also may include a scanning device that is portable and/or that has no input keyboard or monitor screen. In this embodiment, the scanning detection device communicates using an input spectrograph and an output of a series of lights (e.g., green, yellow, blue, red and the like) mounted on the scanning device or a display screen with system information displayed. A serial number is included in the display and stored information so that the device can be uniquely identified for legal prosecutable purposes.

The disclosed system also may include a UVF/SR detection system that can include a concentrator for airborne materials comprising a vacuum device (e.g., portable vacuum cleaner) operatively coupled to the UVF/SR detections system with physical filter material over the intake to draw particles from the environment surrounding the area of interest and where a filter is then used as the target. The UVF/SR detection system of the present design emits light from single or multiple light sources, such as from an LED, laser, laser diode or flashlamp, to excite emission in different substances as well as exciting different emissions in the same substance. The light source may be pulsed, square-wave modulated, and/or continuous wave and may include single and/or multiple sources for complete scene illumination (e.g., rotate LED's, etc.).

The UVF/SR detection system of the present design may gather spectral signatures with a spectrally selective detector, including, for example, conventional spectrometers, spectrally filtered photodetectors, spectrometers using Multimodal Multiplex Spectroscopy™, or any other form of spectral detection. In another aspect, the UVF/SR detection system digitizes the obtained spectral signatures. The UVF/SR detection system applies unique algorithms for signal processing, including, but not limited to embedded processors using filtered FFT, synchronous detection, phase-sensitive detection, digital filters unique to each particular substance being detected and AI.

The UVF/SR detection system mainly uses AI for substance identification and may or may not store the processed data for inclusion in a commercial database available from the cloud. In another aspect, the UVF/SR detection system of the present design displays the obtained spectral signatures or the results of a comparison of the obtained spectral signatures to a database of known or previously obtained spectral signatures.

The UVF/SR detection system may include a handheld or battery-operated device employing the features described in this present design description. The UVF/SR detection system also may include a GPS locater internally mounted within the UVF/SR detection system or in a handheld component of such system. One embodiment of the UVF/SR detection system determines the distance to target in order to keep the system within a sensitive range. The UVF/SR detection system also may communicate wirelessly to a remote location. The UVF/SR detection system may include cellular or other remote access communications capabilities.

In general, the disclosed system provides a mechanism for collecting unique identifications (i.e., gathers information such that the identifications may be determined in a timely manner) of target materials that are used to distinguish them from other similar substances without prior knowledge of the substance (i.e., no single “unique identifiers” required). The identifications may include any quantifiable characteristic(s) pertaining to the substance, such as excitation wavelengths, barcodes, electronic signatures, and the like, negating any requirement for a single unique identifier. The disclosed system also may include an accessible database of known characteristic(s) pertaining to certain agents and substances. An accessible computer system or other storage means (e.g., the cloud) enables the time, place and type of substance administered to be documented.

A broadband source may be used to generate fluorescence and specular reflection within a target area causing detectable emission at UV wavelengths that can be uniquely matched to known materials.

Separate detection channels may be used for the specular reflection portion of this present design.

In another embodiment of the present design, the system can be used to simultaneously evaluate a group of different substances for example, methamphetamine and TATP explosive. In this embodiment, the operator can be permitted to manipulate a combined spectrum of a group of different powders, or other chemical substances, and use the combined spectra to identify unauthorized or inappropriate variations. Such variations can include dangerous mixtures of partially completed mixes or additions and/or quality control verifications. Spectra of individual substances can also be combined to identify specific substances such as pharmaceuticals, biologicals, and explosives.

The detection of emission photons is accomplished with a receiver that may include optics, a spectrograph, or a detector array. The disclosed system may include an analysis system that identifies particular substances of interest. The disclosed system preferably operates within the UV-visible radiation wavelength range of approximately 200 nanometers to approximately 900 nanometers. The disclosed system, however is not limited to this wavelength range as the present design can operate within other wavelength ranges.

Multispectral excitation and/or detection is accomplished with the present design in a number of ways. Selection and control of either excitation wavelengths and/or detection wavelengths can be accomplished using, among other things, a pulsed power sources (e.g., a sequence-pulsed laser system) in conjunction with data collection corresponding to each pulse, a spectral filter wheel(s) to select or vary different excitation or detection wavelengths and combinations thereof. The commercial availability of LED's allows miniaturization and power consumption optimization of the handheld system.

The features disclosed above may be incorporated within a detection system. Examples of handheld or stand-alone detection systems are shown in FIG. 1. FIG. 1 depicts a detection system 4 used as a handheld device according to the disclosed embodiments. Detection system 4 includes housing 5 which includes the electronics and components to perform the detection functions. These elements are disclosed in greater detail below. A handheld detection system is designed to be used or operated while held in a hand of a user.

The front of housing 5 includes optical assemblies for energy emitters 1 as well as for detectors 2.

Housing 5 of detection system 4 also may include angled compartments 3 which house pointing devices (e.g., lasers) that allow distance determination where the beams cross at a desired distance.

Detection system 4 also includes display 6 that provides visual indication to the user of the results of detection operations. Scan button 7 may initiate detection operations.

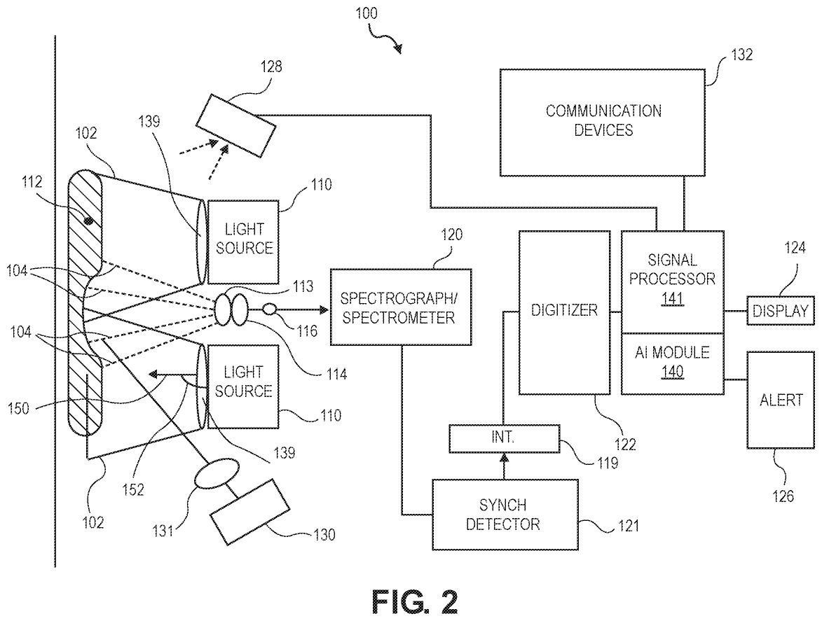

FIG. 2 depicts the components of a UVF/SR detection system 100 in accordance with some embodiments. Excitation energy 102 from one or more excitation (i.e., light) sources 110 within detection system 100 is directed through a spectral filter 139 at a target material 112 in order to generate an emission. Although two light sources 110 are shown, the disclosed embodiments may include any number of excitation sources, including using only a single light source. Preferably, light source or sources 110 may produce narrow-band energy of about 10 nanometers or less. More preferably, the narrow-band energy is about 3 nanometers or less. Light sources 110 may be turned on and off quickly, such as in a range of about or less than 0.01 of a second. Preferably, light sources 110 may be turned on and off within a time period of about 0.001 second.

Emission energy 104 from the targeted material is detected through an optic 114 and is enhanced by a connected low-pass spectral filter 116 prior to being analyzed by a coupled spectrograph/spectrometer or detector array 120. Visible light filter 113 may be located in front of optic 114. Visible light filter 113 helps prevent a large spectrum of light from entering the system so that the large spectrum does not overload the subsequent components with information.

Spectrometer 120 [or array of detectors] is coupled to synchronous detector 121. Synchronous detector 121 is ON when light sources 110 are ON. Preferably, a return signal of emission energy 104 is received and processed when light sources 110 are ON. A problem with optical methods of substance detection is that unwanted light may enter detection system 100. Because of the sensitivity of the components of detection system 100, unwanted light may interfere with the desired light response resulting from light sources 110 (or any illumination source).

Light sources 110 may be modulated within a range of about 100 Hz to 3000 Hz to ensure that the response, such as emission energy 104, from target material 112 is the predominate signal received by synchronous detector 121. Synchronous detector 121 is synchronized to this light modulation in phase and frequency. Also, an angle 152 between a central ray 150 from the excitation light source 110 and an optical axis is adjustable to reduce energy from non-Lambertian surface reflections from unwanted substances or surfaces. Thus, detection system 100 responds to the desired substance response while rejecting light of other frequencies and phases outside the narrow passband invoked by the filters of detection system 100. Moreover, a detector “ON” during the entire process would pick up shakiness or other movements of detection system 100. The disclosed embodiments help mitigate such interference.

Synchronous detector 121 is coupled to integrator 119. The signal detected by synchronous detector 121 is rectified for further processing. Integrator 119 rectifies the AC signal from synchronous detector 121 to a corresponding DC signal or signal with a DC component. The rectification of the signal helps extract the data within the detected signal by subsequent components of detection system 100.

After being rectified by synchronous detector 121 and integrator 119, the resulting data signal is processed and digitized with a digitizer 122. Alternatively, digitizer 122 may receive a voltage signal indicative of the data signal received by spectrometer 120. Signal processor 141 (or processing system, processing logic) receives and further processes the digitized data, and provides the digitized data to other components within detection system 100 or to a cloud entity. The collected data may be imaged on a display 124 or reported (e.g., by a buzzer/audible device or a display light) by alert 126.

Detection system 100 also may include a camera 128 for visually recording the target material 112. Detection system 100 also may include various communication devices 132 (e.g., a cell phone, GPS module, a wireless interface) as well as a data storage mechanism. These devices may transmit and receive information from other sources, and be used to backup information detected and generated by detection system 100. Devices 132 also may be modular in that they are separable from detection system 100 as needed.

Detection system 100 also may include a distance sensor 130 (e.g., optical sensor, ultrasonic sensor, etc.) for measuring the offset distance of the device from the targeted material. Red passband filter 131 is located between distance sensor 130 and target material 112. Distance sensor 130 may provide different results due to different surfaces within target material 112.

Thus, the output of synchronized detector 121 may be rectified, processed and filtered to produce a resultant DC voltage that constitutes the response from target material 112. This signal from synchronized detector 121 is digitized, received by signal processor 141, and applied to AI module 140 which provides an indication of detection or non-detection of a substance of interest. The signal processor 141 can be integrated with or separate from the AI module 140. The instruction of the AI software can be executed with the AI module 140 or at least partially with an AI module of a cloud entity.

Regardless of the particular configuration, the sensitivity limits of the system can depend on any of several factors. These factors can include: energy source availability, cross-section of photoelectric absorption, path length, detector collecting area, detector spectral resolution, detector geometrical characteristics, signal integration time, and detector noise limit. A number of steps have been taken to optimize these factors for detection.

The disclosed system may use a continuous output deuterium ultraviolet source with narrow-band interference filter(s) to define the excitation spectral properties. In such an arrangement, the power density available at full output power is approximately 1 mW/cm². The UV output is collected by a lens of about 1 cm² collecting area and directed from the target area to the detection system. The lens collects energy from a concentrated illuminated spot (about 15 mm diameter) on a target at an approximately 40 mm standoff.

The cross-section of the target is optimized for photoelectric absorption by selecting a fixed spectral filter for each illumination source. Simultaneously, a receiver comprising an array of detectors views the target area. Thereafter, quick emission samples (or exposures) are recorded and the resultant spectra applied to the AI module for discrimination and identification. Using this system, in one example, detection sensitivities of approximately 1.5 nanograms/100 cm² with methamphetamine have been achieved in a 15 mm diameter area at a standoff distance of 40 mm.

The disclosed system also provides the ability to detect and analyze substances within target areas at substantial standoff distances whether in liquid, solid or gaseous form. The disclosed system also may be adapted to be used in unique and varied system configurations (including critical component placement). The disclosed system includes the creation, update and maintenance of a database of unique signatures for individual and complex mixtures of substances. In this regard, the present design can utilize miniature spectrograph instruments coupled to detector arrays with high efficiency power capabilities and novel source optics design.

The disclosed systems include handheld devices for the detection of unknown substance, including, for example, methamphetamine, fentanyl, and their chemical precursors. These embodiments of the present design enable real time detection of illicit drugs and illicit drug production. Detection of methamphetamine, for example, is accomplished by passing the spectral beam over a surface contaminated with trace quantities of methamphetamine. In this regard, the present design is well suited for addressing issues related to the illicit production and distribution of amphetamine and amphetamine-like substances, and for home inspection scenarios where excess amounts of substance detection can lead to a cleanup process.

For example, illegal laboratories that manufacture methamphetamines remain a serious challenge facing law enforcement officers. Remediation of methamphetamine laboratories is a required step prior to permitting re-occupancy of the house or other contaminated structure where an illicit lab was located because residual chemicals may pose health concerns in residential structures even after the laboratory equipment has been removed.

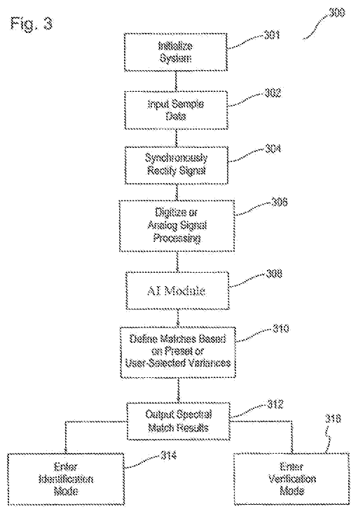

FIG. 3 depicts a flowchart 300 of a method for matching measured photoemission data with known signature spectra of certain compounds according to some embodiments. In one example, a handheld detection system, a processing system (e.g., processing logic, processor) of the handheld detection system, or cloud based processing of a cloud entity performs operations of FIG. 3. In FIG. 3, at operation 301, the method includes initializing the detection system, such as detection system 100, potentially checking for proper component and system operation. At operation 302, the method includes inputting sample data. The data from an evolving sample spectrum being acquired is supplied to the system. At operation 304, the method includes synchronously rectifying the signal received by detection system 100. The signals received by synchronous detector 121 are rectified. At operation 306, the method includes digitizing or performing analog signal processing. Detection system 100 may apply algorithms to the acquired sample data. This operation can include, for example, application of a 20th order power series of cosine functions for curve matching or a Fast Fourier Transform (FFT) analysis. At operation 308, the method includes applying AI of AI module 140 or AI of a cloud entity to the data it receives, and computing the likelihood that the signals it receives correspond to a known combination of signals from previously measured and identified substances. Operation 308 can include, for example, using a least-square curve-fitting routine or FFT that reduces the measured spectrum to a small set of digital numbers sufficient to describe the key information contained in the spectrum, including using up to a 24th-order equation to manipulate the digitized information (or its coefficients if transformed to frequency space by an FFT).

At operation 310, the method includes defining matches based on preset or user-selected variances. Detection system 100 determines whether there has been a match based on the comparison procedure in operation 308. A match can be defined as a preset standard deviation between values from the sample spectrum and those of stored spectra, such as, for example, three standard deviations above or below an average value of a stored spectrum).

At operation 312, the method includes outputting spectral match results. Detection system 100 outputs the results of any matches. Operation 312 is followed by either (or both) of operations 314 (in which the system provides spectral results for visual inspection by the operator and/or provides overlays of the produced spectra) and operation 316 (in which visual and/or audible alarms indicate a match). At operation 314, the method includes entering an identification mode, as disclosed above. At operation 316, the method includes entering a verification mode, also disclosed above.

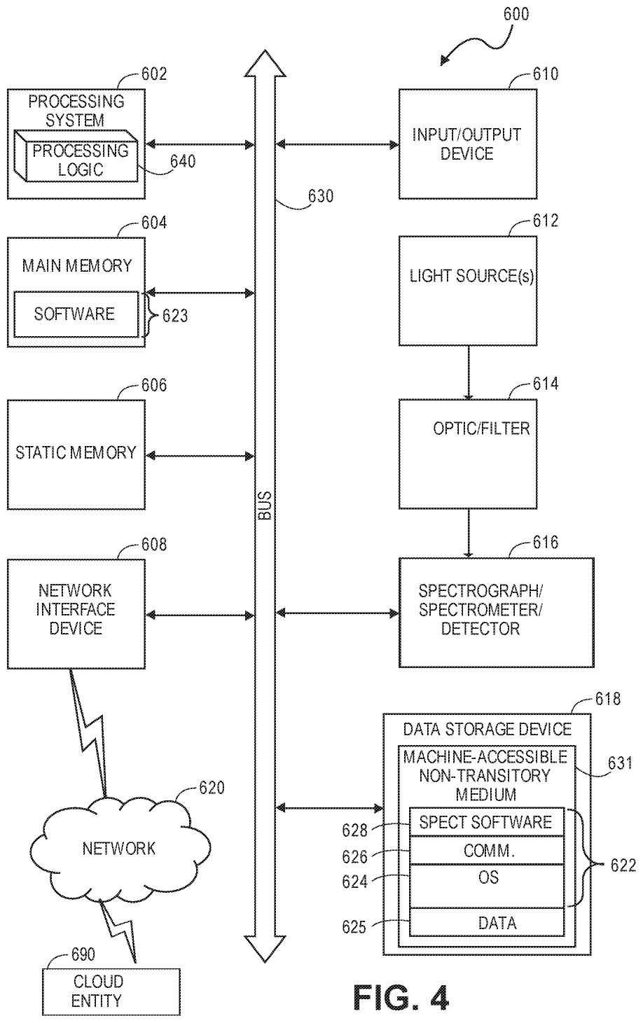

FIG. 4 illustrates a diagrammatic representation of a machine in the exemplary form of a computer system or device 600 within which a set of instructions, for causing the machine to perform any one or more of the methodologies discussed herein, may be executed, in accordance with one embodiment. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a mobile device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary device 600 (e.g., UVF/SR detection device or system 600) includes a processing system 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

The UVF/SR detection system 600 is configured to execute instructions to perform algorithms and analysis to determine at least one of specific substances detected.

The UVF/SR detection system 600 is configured to collect data and to transmit the data directly to a remote location such as cloud entity 690 that is connected to network 620. A network interface device 608 transmits the data to the network 620. The data collected by the UVF/SR detection system 600 can be stored in data storage device 618 and also in a remote location such as cloud entity 690 for retrieval or further processing.

Processing system 602 represents one or more general-purpose processing devices such as a microprocessor, central processing unit, or the like. More particularly, the processing system 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing system 602 may also be one or more special-purpose processing devices such as an application specific integrated circuit (ASIC), a field programmable gate array (FPGA), a digital signal processor (DSP), network processor, or the like. The processing system 602 is configured to execute the processing logic 640 for performing the operations and steps discussed herein. The processing system 602 may include a signal processor 141, AI module 140, digitizer 122, int. 119, and synch detector 121 of FIG. 2.

Excitation energy from one or more excitation (i.e., light) source(s) 612 is directed through a spectral filter at target material(s) in order to generate an emission. Although light source(s) 612 are shown, the disclosed embodiments may include any number of excitation sources, including using only a single light source. Preferably, light source or sources may produce narrow-band energy of about 10 nanometers or less. More preferably, the narrow-band energy is about 3 nanometers or less. Light sources may be turned on and off quickly, such as in a range of about or less than 0.01 of a second. Preferably, light sources may be turned on and off within a time period of about 0.001 second.

Emission energy from the targeted material is detected through an optic/low-pass spectral filter 614 prior to being analyzed by a coupled spectrograph/spectrometer or detector array 616. Visible light filter may be located in front of optic 614. Visible light filter helps prevent a large spectrum of light from entering the system so that the large spectrum does not overload the subsequent components with information.

Spectrometer 616 [or array of detectors] is coupled to a synchronous detector of the processing system 602.

The device 600 may further include a network interface device 608. The device 600 also may include an input/output device 610 or display (e.g., a liquid crystal display (LCD), a plasma display, a cathode ray tube (CRT), or touch screen for receiving user input and displaying output.

The data storage device 618 may include a machine-accessible non-transitory medium 631 on which is stored one or more sets of instructions (e.g., software 622) embodying any one or more of the methodologies or functions described herein. The software 622 may include an operating system 624, spectrometer software 628 (e.g., UVF/SR detection software), and communications module 626. The software 622 may also reside, completely or at least partially, within the main memory 604 (e.g., software 623) and/or within the processing system 602 during execution thereof by the device 600, the main memory 604 and the processing system 602 also constituting machine-accessible storage media. The software 622 or 623 may further be transmitted or received over a network 620 via the network interface device 608.

The machine-accessible non-transitory medium 631 may also be used to store data 625 for measurements and analysis of the data for the UVF/SR detection system. Data may also be stored in other sections of device 600, such as static memory 606, or in cloud entity 690.

In one embodiment, a machine-accessible non-transitory medium contains executable computer program instructions which when executed by a data processing system cause the system to perform any of the methods discussed herein.

The disclosed embodiments allow for an extensive number of applications. A non-exclusive list includes, but is not limited to: any industries, processes and/or equipment requiring remote, non-invasive sensing of multiple chemical compounds or constituents (such as in the chemical, petroleum and other similar industries, biological materials being examined for diseases, internal pollution and contamination controls, external pollution and contamination controls, illegal drug detection and monitoring, commercial drug quality control and dispensing verification, nuclear waste and effluent monitoring, air standards determination, explosives monitoring and detection, semiconductor industry effluent monitoring and control, hazardous waste and emission monitoring, semiconductor quality control measures, semiconductor processing contamination monitoring and control, plasma monitoring and control, waste dump site monitoring and control, nuclear, biological, and chemical weapons by-products monitoring, clean room monitoring and control, clean room tools monitoring, vacuum controls, laminar flow controls and controlled environments); security monitoring (including airport and transportation security, improvised explosive device (IED) detection, military and civilian ship and building security, drug (illegal and commercial) security, explosives, weapons and bio-hazard manufacture, detection and storage); direct and indirect identification of biological molecules, either extracted from an organism or in vivo; remediation (including of hazardous and toxic materials, chemicals, buried land mines, unexploded ordinance, and other explosive devices).

It will be apparent to those skilled in the art that various modifications and variations can be made in the disclosed embodiments of the privacy card cover without departing from the spirit or scope of the invention. Thus, it is intended that the present invention covers the modifications and variations of the embodiments disclosed above provided that the modifications and variations come within the scope of any claims and their equivalents.

What is claimed is:

1. A handheld individual channel to multi-channel detection system comprising:
single or multiple excitation light sources at discrete wavelengths operating in an ultraviolet portion of an electromagnetic spectrum, wherein the single or multiple excitation lights source are operated intermittently, either all in concert or individually, at a frequency of about 100 Hz to 1000 Hz; and
multiple detectors configured as channels to operate at discrete wavelengths to detect a multiplicity of emissions produced by the excitation energy, and a multi-channel electronic or software-implemented detector that is synchronized in both phase and frequency with the excitation light sources so that a signal of interest is detected in the multiplicity of emissions.

2. The system of claim 1, further comprising:
a processor coupled to the multi-channel electronic or software-implemented detector, the processor is configured to execute instructions to apply artificial intelligence (AI) of an AI module to various combinations of sources activated, and their subsequent responses in detector channels of the multi-channel electronic or software-implemented detector; and
a variable database that includes known substances and subsequently learned substance signatures resulting from applying the AI, wherein the variable database provides signature data that matches spectral data of the signal of interest to identify at least one of a plurality of predetermined chemical substances.

3. The system of claim 2, wherein the AI module to generate the variable database.

4. The system of claim 2, wherein data of the variable database is stored in a cloud entity at a remote location from the system.

5. The system of claim 1, wherein the single or multiple excitation light sources produce a narrow-band of three nanometers or less, and comprise at least one of a light emitting diode, a laser, a laser diode, a flashlamp and combinations thereof.

6. The system of claim 1, wherein the single or multiple excitation light sources comprise at least one of a pulsed light source, a square-wave modulated light source, a continuous wave light source and combinations thereof.

7. The system of claim 1, wherein said system determines a distance to a target with an optical or ultrasonic distance sensor.

8. The system of claim 1, further comprising an integrator to rectify the signal of interest from the synchronous detector.

9. The system of claim 1, further utilizing a global positioning system (GPS) for reporting of precise location of the detection.

10. The system of claim 1, wherein said system has a functional standoff distance of approximately 1 inch to approximately 12 inches.

11. The system of claim 1, further comprising at least one of optics, a spectrograph and a detector array.

12. The system of claim 1, wherein said system operates with a radiation wavelength range of approximately 200 nanometers to approximately 900 nanometers.

13. The system of claim 1, wherein an angle between a central ray from the excitation light source and an optical axis is adjustable to reduce energy from non-Lambertian surface reflections from unwanted substances or surfaces.

14. The system of claim 1, wherein data from the handheld individual channel to multi-channel detection system are presented to a cell phone.

15. The system of claim 1, wherein data from the handheld individual channel to multi-channel detection system are stored and processed with artificial intelligence (AI) software in a cloud based database of a cloud entity.

16. A method for detecting a substance using a handheld photoemission spectroscopy detection system, the method comprising:
operating the handheld photoemission spectroscopy detection system in an ultraviolet portion of an electromagnetic spectrum;
receiving composite spectral data at a synchronous detector of the handheld photoemission spectroscopy detection system, wherein the synchronous detector detects a signal of interest from the composite spectral data; and
retrieving signature data for a predetermined chemical substance from a database based on the signal of interest.

17. The method of claim 16, further comprising:
applying artificial intelligence (AI) of an AI module to the signal of interest;
computing a likelihood that the signal of interest corresponds to the signature data including a known combination of signals from previously measured and identified substances; determining whether any match occurs between the signal of interest and the signature data; and outputting spectral match results.

18. The method of claim 16, wherein the handheld photoemission spectroscopy detection system includes an ultraviolet fluorescence detector to operate in conjunction with
an excitation light source,
a low-pass spectral filter,
the synchronous detector, and
a visible light filter.

19. A handheld photoemission spectroscopy detection system comprising:
a miniature scanning detection system operating in an ultraviolet portion of an electromagnetic spectrum including:
a plurality of light emitting diodes (LEDs), wherein each of the plurality of LEDs emit within a specified portion of the electromagnetic spectrum;
at least one low-pass spectral filter;
a visible light filter;
a spectrometer to detect a plurality of emissions from the plurality of LEDs; and
a synchronous detector coupled to the spectrometer, and synchronized to a phase or a frequency of the plurality of LEDs to detect a signal of interest from the plurality of emissions.

20. The handheld photoemission spectroscopy detection system of claim 19, further comprising:
a processor coupled to the spectrometer to receive spectral data corresponding to the signal of interest; and
an AI module coupled to the processor, the AI module is capable of generating a database that includes signature data for a plurality of predetermined chemical substances, wherein the database provides signature data that matches the spectral data of the signal of interest to identify at least one of a plurality of predetermined chemical substances.
